(19) United States
(12) Patent Application Publication
(10) Pub. No.: US 2026/0310904 A1
(43) Pub. Date: Oct. 8, 2026

(54) NATURAL LANGUAGE PROCESSING-BASED USER PROFILING FOR PERSONALIZED SERVICES

(71) Applicant: OpenAI OpCo, LLC., San Francisco, CA (US)

(72) Inventors: Samir Ahmed, San Francisco, CA (US); Christina Kaplan, San Francisco, CA (US); Constantin Koumouzelis, Mountain View, CA (US); Marvin Zhang, San Francisco, CA (US)

(73) Assignee: OpenAI OpCo, LLC., San Francisco, CA (US)

(21) Appl. No.: 19/207,473

(22) Filed: May 14, 2025

Related U.S. Application Data
(60) Provisional application No. 63/784,747, filed on Apr. 7, 2025.

(51) Int. Cl. G06F 40/40

(52) U.S. Cl. CPC G06F 40/40

(57) ABSTRACT

Systems and methods for utilizing generative response engines to create and maintain Natural Language Representations (NLRs) for user personalization across multiple service providers are provided. Past interaction data between a user account and various service providers are evaluated and specialized instances of generative models tailored for each service provider's specific category of services are employed. The representations are continuously generated in an asynchronous process, allowing seamless updates without disrupting operational efficiency.

### CROSS-REFERENCE TO RELATED APPLICATIONS

This application claims the benefit of priority to U.S. provisional application number 63/784,747, filed on Apr. 7, 2025, entitled NATURAL LANGUAGE PROCESSING-BASED USER PROFILING FOR PERSONALIZED SERVICES, which is expressly incorporated by reference herein in its entirety.

### BACKGROUND

Generative response engines such as large language models represent a significant milestone in the field of artificial intelligence, revolutionizing computer-based natural language understanding and generation. Generative response engines, powered by advanced deep learning techniques, have demonstrated astonishing capabilities in tasks such as text generation, translation, summarization, and even code generation. Generative response engines can sift through vast amounts of text data, extract context, and provide coherent responses to a wide array of queries.

### BRIEF DESCRIPTION OF THE SEVERAL VIEWS OF THE DRAWINGS

Details of one or more aspects of the subject matter described in this disclosure are set forth in the accompanying drawings and the description below. However, the accompanying drawings illustrate only some typical aspects of this disclosure and are therefore not to be considered limiting of its scope. Other features, aspects, and advantages will become apparent from the description, the drawings, and the claims.

FIG. 1 illustrates an example system supporting a generative response engine during inference operations in accordance with some aspects of the present technology.

FIG. 2 illustrates an example context management service supporting a generative response engine during inference operations in accordance with some aspects of the present technology.

FIG. 3 is an example table that compares snippets from conversation threads with a respect natural language representation tree in accordance with some aspects of the present technology.

FIG. 4 illustrates an example landing page that uses a natural language representation of a user account for outputting customized recommendations in accordance with some aspects of the present technology.

FIG. 5 illustrates an example method for providing a natural language representation of a user account for outputting customized recommendations in accordance with some aspects of the present technology.

FIG. 6 illustrates an example method for providing a natural language representation of a user account for outputting customized recommendations in accordance with some aspects of the present technology.

FIG. 7 illustrates an example method for context management for a generative response engine in accordance with some aspects of the present technology.

FIG. 8 is a block diagram illustrating an example machine-learning platform for implementing various aspects of this disclosure in accordance with some aspects of the present technology.

FIG. 9A, FIG. 9B, and FIG. 9C illustrates an example transformer architecture in accordance with some aspects of the present technology.

FIG. 10 shows an example of a system for implementing some aspects of the present technology.

### DETAILED DESCRIPTION

Generative response engines such as large language models represent a significant milestone in the field of artificial intelligence, revolutionizing computer-based natural language understanding and generation. Generative response engines, powered by advanced deep learning techniques, have demonstrated astonishing capabilities in tasks such as text generation, translation, summarization, and even code generation.

Many generative response engines provide a conversational user interface powered by a chatbot whereby the user account interacts with the generative response engine through natural language conversation with the chatbot. Such a user interface provides an intuitive format to provide prompts or instructions to the generative response engine. In fact, the conversational user interface powered by the chatbot can be so effective that users can feel as if they are interacting with a person. Some user accounts find the generative response engine effective enough that they utilize the conversational user interface powered by the chatbot as they would an assistant. One area in which generative response engines could be improved is their use for personalizing services and content to users.

Other types of services such as websites and applications typically represent personalized data and preferences as vectors. Representing personalized data and preferences as vectors has several drawbacks. One of the significant issues is that it can lead to a disconnect between how users perceive their personalized data and how services interpret it, resulting in a loss of human-intuitive understanding. Furthermore, the complexity of vector representations increases with the number of dimensions (features), making it difficult to understand and identify patterns or relationships within the data that are relevant to individual users. Additionally, vectors are a translation of some explicit or inferred preference or behavior into a numerical space, which can result in vectors that often lack contextual information or lack nuance, which limits their usefulness.

The present technology addresses these problems by allowing a context management service to create a natural language representation of personalized data and preferences. The natural language representation may incorporate linguistic and semantic information that closely aligns with human understanding and intuition. Additionally, the natural language representation does not require a translation from the space in which the data is created (natural language) into another form to be useful. And, natural language is far more expressive than a vector of numbers across dimensions, so descriptions in natural language can convey more information and more nuance than a numerical representation. Therefore, the natural language representation can be a better representation of the preferences and behaviors of the user.

By leveraging advanced natural language processing (NLP) techniques, the context management service can generate a rich and nuanced representation of each user's personalized data and preferences. The result is a more human-intuitive understanding of each user's unique needs and preferences, which enables the generative response engine to provide more accurate, relevant, and sensitive responses. This approach also allows for better contextualization of the user's input, enabling the system to capture the nuances of human language and behavior in a way that was previously impossible with vector-based representations.

The present technology also addresses the issue of scalability and complexity by providing a flexible and adaptable framework for managing user data and preferences. This framework allows for easy integration with existing systems and can be easily scaled up or down as needed, making it an attractive solution for organizations looking to implement AI-powered conversational interfaces.

Another advantage of the present technology is that a natural language representation of a user matches the preferred type of input into a language model, which is the most promising form of artificial intelligence that exists today. Therefore, not only is a natural language representation a better representation of a user since the data to create the natural language representation is derived from natural language representation but it is the preferred input to a large language model. Thus the present technology represents an important advance in personalization technologies.

The natural language representation may be an output from a machine learning (ML) model that approximates what the ML model should remember about the user account if the ML model were their assistant. These summaries go beyond mere preferences and behaviors, instead providing a condensed record of past interactions between the ML model and the user. Moreover, natural language representations can be generated across conversations, connecting disparate concepts that may have appeared in separate conversation threads. These natural language representations may be derived from analyzing patterns and trends in the user's interactions over time. Additionally, the natural language representations can be dynamically generated and updated by a context management service, ensuring they remain relevant and accurate. In some cases, the ML model contextualizes insights from the long-term memory storage and selectively adds them to the natural language representation.

In some cases, a specialized instance of the generative response engine evaluates past interaction data between a user account and a service provider, wherein the specialized instance of the generative response engine is trained to determine what information should be synthesized into the natural language representation of the user account. For example, the specialized instance of the generative response engine may be trained to create the natural language representation that represents the user account's interest in consumption of a category of services, which may include services such as music services, advertising services, food services, hobby services, sports services, etc. In other words, the same user account could have several different natural language representations. There could be a natural language representation that summarizes recent happenings, which might be akin to recent memories. There could be a natural language representation of a user account's interest in music, which would be akin to a music taste profile and used to customize a music service experience. There could be a natural language representation of a user account's recent commercial transactions, which could be used to serve relevant advertising. There could be a natural language representation of a user account's use of a computing device, which could be used to organize a home screen of apps and websites and important information, or to suggest replies to messages received on that device. There could be a natural language representation for any use case or dimension that can be defined.

One aspect of the present technology may be the gathering and use of data available from various sources that may include personal information data that uniquely identifies or can be used to contact or locate a specific person. Such personal information data can include demographic data, location-based data, telephone numbers, email addresses, twitter ID's, home addresses, data or records relating to a user's health or level of fitness (e.g., vital signs measurements, medication information, exercise information), date of birth, or any other identifying or personal information.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Further, such collection/sharing should occur after receiving the informed consent of the users.

Despite the foregoing, the present disclosure also contemplates aspects in which users selectively block the use of, or access to, personal information data. That is, the present disclosure contemplates that hardware and/or software elements can be provided to prevent or block access to such personal information data. For example, the present technology can be configured to allow users to select to “opt in” or “opt out” of participation in the collection of personal information data during registration for services or anytime thereafter.

Therefore, although the present disclosure broadly covers use of personal information data to implement one or more various disclosed aspects, the present disclosure also contemplates that the various aspects can also be implemented without the need for accessing such personal information data. That is, the various aspects of the present technology are not rendered inoperable due to the lack of all or a portion of such personal information data. For example, content can be selected and delivered to users by inferring preferences based on non-personal information data or a bare minimum amount of personal information, such as the content being requested by the device associated with a user, other non-personal information available to the content delivery services, or publicly available information.

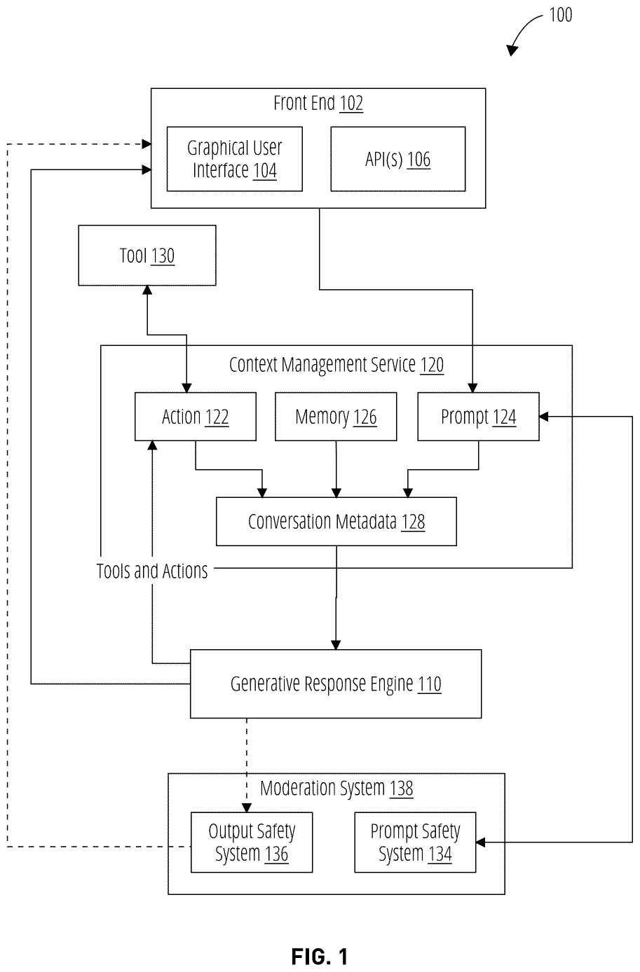

FIG. 1 illustrates an example AI assistant service supporting a generative response engine during inference operations in accordance with some aspects of the present technology. Although the example system depicts particular system components and an arrangement of such components, this depiction is to facilitate a discussion of the present technology and should not be considered limiting unless specified in the appended claims. For example, some components that are illustrated as separate can be combined with other components, and some components can be divided into separate components.

The generative response engine 110 is an artificial intelligence (AI) that can generate content in response to a prompt. The prompt can be from a human or a software entity (AI or applications). The prompt is generally in natural language but could be in code, including binary. Some examples of the generative response engine can include language models that generate language, such as CHATGPT, or other models, such as DALL-E, which generates images, and SORA, which generates videos. CHATGPT, DALL-E, and SORA are all provided by OPENAI, but the generative response engine is not limited to AI provided by OPENAI. The generative response engine can also be any type of generative AI and can include AI developed using various architectures such as diffusion models and transformers (e.g., autoregressive transformer architecture) and combinations of models.

In some instances, a language model, such as CHATGPT, can receive prompts to output images, video, code, applications, etc., which it can provide by interfacing with one or more other models, as will be addressed further herein.

Users and applications can interact with the generative response engine 110 through the front end 102. The front end 102 serves as the interface and intermediary between the user and the generative response engine. It encompasses the graphical user interface 104 and Application Programming Interfaces (APIs) 106 that facilitate communication, input processing, and output presentation. Generally, users interact through a graphical user interface 104 that often includes a conversational interface, and applications interact through the API 106, but this is not a requirement.

The graphical user interface 104 is the platform through which users interact with the generative response engine 110. It can be a web-based chat window, a mobile application, or any interface that supports data input and output. The graphical user interface 104 facilitates a conversation between the user and the generative response engine, as the user provides prompts in the graphical user interface 104 to which the generative response engine responds and presents those responses in the graphical user interface 104. In some aspects, graphical user interface 104 presents a conversational interface, which has attributes of a conversation thread between a user account and generative response engine 110.

The graphical user interface 104 is configured to perform input handling, context management, and output presentation. The type of inputs that can be received can be relative to the specifics of the generative response engine 110. For example, a language model is generally configured to accept text, but when the generative response engine is a multi-modal generative response engine, the front end 102 can accept voice and images/video.

In some aspects, front end 102 can be an interface to accept any input types as part of the prompt, and downstream services can determine which generative response engine or collection of generative response engines are best suited to respond to the prompt.

The graphical user interface 104 is also configured to maintain the context of the conversation, which allows for coherent and relevant responses. For example, the graphical user interface 104 is responsible for providing the conversation thread and other relevant context accessible to the front end 102 to the generative response engine along with the specific prompt to the generative response engine. In an example, a conversation between the user account and the generative response engine 110 can have taken several turns (prompt, response, prompt, response, etc.). When the user account provides a further prompt, the graphical user interface 104 can provide that prompt to the generative response engine in the context of the entire conversation.

In another example, the graphical user interface 104 might be configured to provide a system prompt along with a user-provided prompt. A system prompt is hidden from the user account and is used to set the behavior and guidelines for the generative response engine. It can be used to define the AI's persona, style, and constraints. There can be levels of system prompts. A highest level of a system prompt might be provided by the generative response engine 110 provider and its meant to establish policies for the behavior of generative response engine 110. This highest level os system prompt should is prohibited from being edited. A customization system prompt can be used to customize the behavior of the generative response engine and is often provided through an API call, or provided by a user account when creating a customized version of generative response engine 110. A still lower level of system prompt might include hidden information about a task. This can include chain-of-thought from a reasoning model, or context about an application the generative response engine 110 is working with to complete a task. Accordingly, the graphical user interface 104 does not always display all of the output of the generative response engine.

The graphical user interface 104 is also configured to display the responses from the generative response engine, which might include text, code snippets, images, or interactive elements.

In some aspects, the generative response engine 110 can provide instructions to the front end 102 that instruct the graphical user interface 104 about how to display some of the output from the generative response engine. For example, the generative response engine can direct the graphical user interface 104 to present code in a code-specific format, or to present interactive graphics, or static images. In other examples, the generative response engine can direct the graphical user interface 104 to present an interactive document editor where the graphical user interface 104 can be presented with the document editor so that the user account and the generative response engine can collaborate on the document.

In some aspects, the generative response engine 110 can provide instructions to memory 126 to record facts in a personalization notepad, and front end 102 can be configured to notify the user account that a memory was created.

As noted above, the front end 102 can also provide one or more application programming interfaces (API(s)) 106. APIs enable developers to integrate the generative response engine's capabilities into external applications and services. They provide programmatic access to the generative response engine, allowing for customized interactions and functionalities. While APIs 106 are shown as part of a front end 102, this illustration takes the liberty of locating API 106 in front end 102 to refer to points of access to generative response engine 110 (i.e., graphical user interface 104 and APIs 106 are points of access and generative response engine 110 sends and receives messages to them in similar ways). In reality, API 106 endpoints are located at context management service 120.

The APIs 106 can accept structured requests containing prompts, context, and configuration parameters. For example, an API can be used to provide prompts and divide the prompt into system prompts and user prompts. In some aspects, the APIs 106 can provide specific inputs for which the generative response engine 110 is configured to respond with a specific behavior. For example, an API can be used to specify that it requires an output in a particular format or structured output. For example, in the chat completion API, the API call can specify parameters for the output, such as the max length for the desired output, and specify aspects of the tone of the language used in the response. Some common APIs are for participating in a conversation (Chat Completion API), for providing a single response (Completion API), for converting text into embeddings (Embeddings API), etc. The API can also be used to indicate specific decision boundaries that the generative response engine 110 might be trained to interpret. For example, the moderation API can take advantage of the AI assistant service 100's content moderation decision-making. In the case of the moderation API and others, the API might give access to services other than the generative response engine. For example, the moderation API might be an interface to moderation system 138, addressed below.

Some other common APIs include the Fine-Tuning API, which allows developers to customize models of the generative response engine using their own datasets; the Audio and Speech APIs, which cause the generative response engine to output speech or audio; and the Image Generation API, which causes the generative response engine to output images (which might require utilizing other models).

There can also be APIs that direct the generative response engine to interface with other applications or other generative AI engines. In such cases, the specific application or AI engine might be specified, or the generative response engine might be allowed to choose another application of AI engine to utilize in response to a prompt.

In short, the graphical user interface 104 and the APIs 106 can be used to provide prompts to the generative response engine. Prompts are sometimes differentiated into prompt types. For example, a system prompt can be a hidden prompt that sets the behavior and guidelines for the generative response engine. A user prompt is the explicit input provided by the user, which may include questions, commands, or information.

Sitting in between front end 102 and generative response engine 110 is a context management service 120. The function of context management service 120 is to manage and organize the flow of data among key subsystems, enabling the generative response engine 110 to generate responses that are contextually relevant, accurate, and enriched with additional information as required.

Action 122 facilitates auxiliary tasks that extend beyond basic text generation. In some aspects, action 122 can be actions that correspond to an API 106. In some aspects, action 122 can be agentic actions that the generative response engine 110 decides to take to carry out a user's intent as described in the prompt. For example, an action can be to call tool 130 or even another generative response engine 110.

Prompt 124 is the request or command provided by the user account through front end 102. In some aspects, prompt 124 can be further supplemented by a system prompt and other information that might be included by graphical user interface 104 or API 106 or associated with a custom generative response engine 110. In some aspects, prompt 124 can even be modified or enhanced by generative response engine 110 as addressed further below. Additionally, as the user account provides prompts and generative response engine 110 provides responses, a conversation thread forms. As the user account provides a new prompt, this is appended to the overall conversation and added to prompt 124. Thus, a user account might think of a first user-provided message as a first prompt and a second user-provided message as a second prompt, and so on, but prompt 124 as perceived by generative response engine 110 can include a thread of user-provided messages and responses from generative response engine 110 in a multi-turn conversation. The actors in the conversation thread can be labeled so that generative response engine 110 can review the turns of the conversation. Generally, prompt 124 will include an entire conversation thread, but in some instances, prompt 124 might need to be shortened if it exceeds a maximum accepted length (generally measured by a number of tokens).

context management service 120 can also route prompts and response through moderation system 138. In some aspects, prompts are provided to prompt safety system 134 before being provided to generative response engine 110. Prompt safety system 134 is configured to use one or more techniques to evaluate prompts to ensure a prompt is not requesting generative response engine 110 to generate moderated content. In some aspects, prompt safety system 134 can utilize text pattern matching, classifiers, and/or other AI techniques.

Since prompts can evolve over time through the course of a conversation, consisting of prompts and responses, prompts can be repeatedly evaluated at each turn in the conversation.

Memory 126 can facilitate continuity and personalization in conversations. It allows the system to maintain user-specific context, preferences, or details that may inform future interactions. A memory file can be persisted data from previous interactions or sessions that provide background information to maintain continuity. In some aspects, memory can be recorded at the instruction of generative response engine 110 when generative response engine 110 identifies a fact or data that it determines should be saved in memory because it might be useful in later conversations or sessions. In some aspects, memory 126 can also include synthesized concepts extracted from past conversation threads, and memory 126 can also encompass the ability of generative response engine 110 to search through past interactions to find relevant information to a current conversation thread.

Conversation metadata 128 can aggregate data points relevant to the conversation, including user prompt 124, action 122, and memory 126. This consolidated information package serves as the input for generative response engine 110. Conversation metadata 128 can label parts of a prompt as user provided, generative response engine provided, a system prompt, memory 126, data from action 122 or tool 130 (addressed below).

The generative response engine is the core engine that processes inputs (from context management service 120) and generates outputs. In some aspects, the generative response engine is a generative transformer, or autoregressive transformer, but it could utilize other architectures. In some examples, the transformer is multi-modal transformer that can use audio tokens (or embeddings thereof), visual tokens (or embeddings thereof), and language (or embeddings thereof) as needed.

A core feature of the generative response engine 110 is to generate content in response to prompts. The generative response engine 110 is configured to receive inputs from front end 102 that provide guidance on a desired output. The generative response engine can analyze the input and identify relevant patterns and associations in the data, and it has learned to generate a sequence of tokens that are predicted as the most likely continuation of the input. The generative response engine 110 generates responses by sampling from the probability distribution of possible tokens, guided by the patterns observed during its training. Two features of the autoregressive transformer that result in this functionality are that the autoregressive transformer might use only the decoder part of the transformer architecture and that it utilizes self-attention. By utilizing the decoder part of the transformer architecture, the transformer focuses on predicting the tokens given the previous context tokens. And the self-attention mechanism captures long-range dependencies amongst tokens, allowing it to generate contextually relevant responses (in text, audio, images, and video).

In some aspects, the generative response engine 110 can generate multiple possible responses before presenting the final one. The generative response engine 110 can generate multiple responses based on the input, and these responses are variations that the generative response engine 110 considers potentially relevant and coherent.

In some aspects, the generative response engine 110 can evaluate generated responses based on certain criteria. These criteria can include relevance to the prompt, coherence, fluency, and sometimes adherence to specific guidelines or rules, depending on the application. Based on this evaluation, the generative response engine 110 can select the most appropriate response. This selection is typically the one that scores highest on the set criteria, balancing factors like relevance, informativeness, coherence, and content moderation instructions/training.

In some aspects, an instruction provided by an API 106, a system prompt, or a decision made by generative response engine 110 can cause the generative response engine 110 to interpret a prompt and re-write it or improve the prompt for a desired purpose. For example, generative response engine 110 can determine to take a prompt to make a picture and enhance the prompt to yield a better picture. In these instances, generative response engine 110 can generate its own prompts, which can be provided to a tool 130 or provided to generative response engine 110 to yield a better output response than the original prompt might have.

The generative response engine 110 can also do more than generate content in response to a prompt. In some aspects, the generative response engine 110 can utilize decision boundaries to determine the appropriate course of action based on the prompt. In some examples, a decision boundary might be used to cause the generative response engine to recognize that it is being asked to provide a response in a particular format such that it will generate its response constrained by the particular format. In some examples, a decision boundary can cause the model to refuse to generate a responsive output if the decision is that the responsive output would violate a moderation policy. In some examples, the decision boundary might cause the generative response engine to recognize that it needs to interface with another AI model or application to respond to the prompt. For example, when the generative response engine is a language model, it might recognize that it is being asked to output an image, and therefore, it needs to interface with a model that can output images to provide a response to the prompt. In another example, the prompt might request a search of the Internet before responding. The generative response engine can use a decision boundary to recognize that it should conduct a search of the Internet and use the results of that search in responding to the prompt. In another example, the prompt might request that the generative response engine take an agentic action on behalf of the user by interacting with a third-party service (e.g., book a reservation for me at . . .) , and the generative response engine can utilize a decision boundary to recognize that it needs to plan steps to locate the third-party service, contact the third-party service, and interact with the third-party service to complete the task and then report back to the user that the action has been completed.

When generative response engine 110 determines that it should take an agentic action on behalf of the user or it should call a tool to aid in providing a quality response to the user account, the generative response engine 110 might call a tool 130 or cause an action 122 to be performed. As indicated above, tools 130 can include internet browsers, editors such as code editors, other AI tools etc. Actions 122 are actions that the generative response engine 110 can cause to be performed, perhaps using tool 130. As used herein actions 122 should be considered to cover a broad array of actions that generative response engine 110 can perform with or without tools 130. Tools 130 are considered to cover a wide variety of services and software that encompass tools such as a computer operating system such that the generative response engine 110 can control the computer operating system on the user's behalf, to robotic actuators, to search browsers and specific applications.

Additionally, the generative response engine 110 can also generate portions of responses that are not displayed to the user. For example, the generative response engine 110 can direct the front end 102 to provide specific behaviors, such as directions for how to present the response from the generative response engine 110 to the user account. In another example, the generative response engine 110 can provide response portions dictated by an API, where portions of the response to the API might be for the consumption of the calling application but not for presentation to the end user. In another example, some generative response engine 110 are reasoning models, which are generative response engine 110 that are configured to output a raw chain-of-thought before preparing a final response to a prompt. The raw chain-of-thought might not be presented to a user account or application calling an API. Instead, another generative response engine 110 might summarize the raw chain-of-thought into a more consumable and useful output for the user account or application.

In some aspects, the output of generative response engine can be further analyzed by output safety system 136. While generative response engine 110 can perform some of its own moderation, there can be instances where it is desired to have another service review outputs for compliance with the moderation policy. The use of dashed lines in FIG. 1 differentiates a path using output safety system 136 and not using output safety system 136.

While FIG. 1 shows responses being provided back to front end 102 directly, in some aspects, the responses might be returned by way of context management service 120.

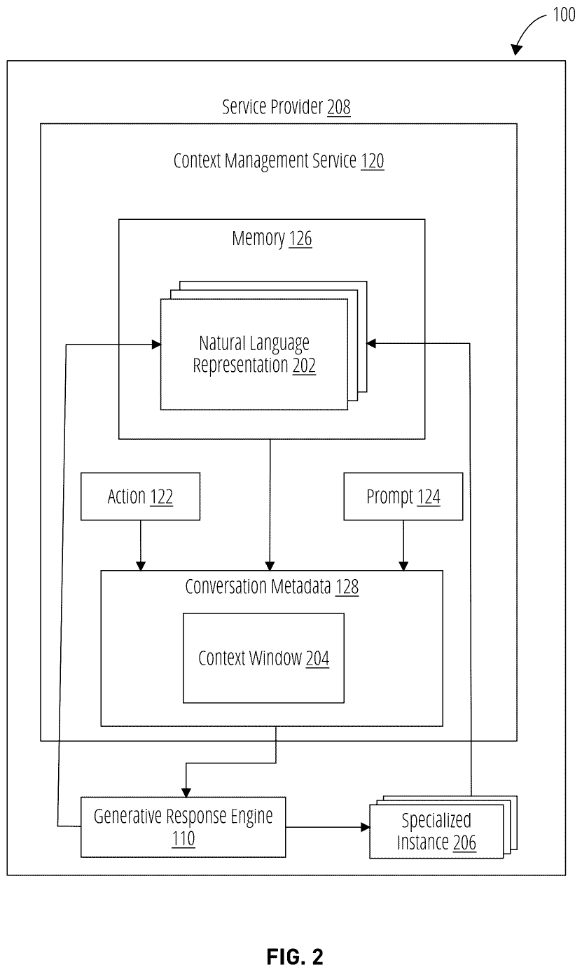

FIG. 2 illustrates an example context management service supporting a generative response engine during inference operations in accordance with some aspects of the present technology.

The context management service 120 of FIG. 1 may include memory 126 that includes natural language representations 202. The natural language representation 202 may be generated from past conversation threads associated with the user account by a specialized instance 206 of the generative response engine 110. The specialized instance 206 may evaluate the past conversation threads and synthesize the natural language representation 202 to capture relevant user information. The specialized instance 206 of the generative response engine 110 may be trained to determine what information should be synthesized into the natural language representations 202.

The conversation threads may include sequences of interactions between the user and the AI assistant service 100, including an exchange of prompts, responses, and feedback. For example, if the user account has had several past conversations with the system about questions regarding new restaurants, discussing their dining experiences, and sharing their food preferences, the context management service 120 could synthesize a representation that captures the essence of the user's behavior and interests, even if the specific details of the past conversations are not retained.

Memory 126 may also include short-term memory, which stores at least a portion of recent conversation threads. Short-term memory may be limited by recency and the available context window 204. The inclusion of short-term memory enhances the ability of AI assistant service 100 to capture dynamic user behaviors and preferences that may not yet be reflected in long-term memory.

For example, a user named John may interact with a trip planning service integrated with the AI assistant service 100. Initially, John may express a general interest in trying new foods and visiting historical sites. The system may generate a natural language representation 202 reflecting his age, location, and adventurous nature. However, if John later receives an email inviting him to a food festival in Tokyo, this recent information may be stored in short-term memory and temporarily associated with his profile. The system may then analyze the connection between John's general interest in food and the food festival, determining that the event aligns with his preferences. Consequently, the AI assistant service 100 may proactively suggest restaurant recommendations at the festival.

The natural language representations 202 may comprise descriptions of experiences, thoughts, feelings, and inferred preferences of the user account, derived from textual interactions recorded in past conversation threads between the user account and a service, as well as textual descriptions generated by the generative response engine. In some implementations, different natural language representations 202 may correspond to the user account's respective interests in consuming different services, such as music services, advertisement services, food services, hobby services, and sports services.

The textual descriptions generated by the generative response engine may also be based on visual data or interaction logs. For example, the generative response engine may receive images or video frames depicting the user's interaction with an application or website, or log files showing mouse movements, user interface selections, and inputs. Based on these inputs, the generative response engine may create a textual description of the interaction, even if the user did not engage in a conventional text-based conversation. For instance, the system might generate a description stating: “Jane is interacting with travelwebsite.com, first browsing travel deals before entering a destination. Jane interacted more with tropical destinations than alternatives. Jane did not select one of the travel deals but ran a query for hotels in Hawaii. Jane showed greater interest in hotels with a 3.5-star rating. Jane did not book a trip during this session.“

In some implementations, natural language representations 202 may be supplemented with visual data, as visual data can provide additional context. However, in some cases, due to potential constraints on storage or processing, the amount of visual data included may be limited. For example, a stored natural language representation 202 may state: “Jane enjoys exploring new and innovative dining experiences, seeking out unique cuisine and restaurant concepts. She is adventurous in her food tastes and appreciates learning about different culinary styles and flavors.” Such a representation extends beyond a mere record of past statements to reflect an AI-generated abstraction of the user's overall preferences and behaviors, synthesized from conversational history and interaction data.

Natural language representations 202 may be generated using different criteria depending on the service provider or application. In some cases, a service provider, such as an advertisement service, may have access to a natural language representation 202 tailored to its specific needs. For example, if a user searches for “living room inspiration,“an advertisement service provider may utilize a natural language representation 202 indicating that the user account frequently shops at vintage or second-hand stores. A specialized instance 206 of the generative response engine fine-tuned for advertising may analyze this information and generate a recommendation prioritizing advertisements for vintage and second-hand furniture stores.

Using natural language representations 202 provides advantages over vector-based representations in various applications, such as targeted advertising. For instance, an AI system can leverage a natural language representation 202 to generate customized recommendations, ensuring that user preferences—such as an interest in vintage and second-hand stores—are explicitly captured rather than inferred from keyword associations. This approach enables a more precise and contextually relevant personalization of services. In some implementations, natural language representations 202 may include audio or visual data, especially if synthesized from interactions that contain such elements.

Additionally, these representations may incorporate a listing of topics derived from past conversations or a summary of at least one topic determined to be relevant. A summary may pertain to a topic occurring in a single conversation thread or across multiple threads, thereby establishing relationships between related discussions. Based on the information in the natural language representations 202, the generative response engine 110 may determine whether to search an archive of past interactions for additional context. In some cases, the natural language representations 202 may be associated with thread identifiers, enabling the specialized instance 206 to retrieve relevant conversation threads for contextual reference.

In some cases, a service provider, such as a trip planning service, may schedule a prompt directing the generative response engine to generate a personalized recommendation based on a user's natural language representation 202. The recommendation may take the form of a personalized homepage, proactive messages, or targeted advertisements tailored to the user's inferred interests.

In some cases, the context management service 120 may support developer-directed signal extraction, wherein a developer or service provider defines a schema specifying categories of behavioral, contextual, or preference-based signals to be synthesized from user history. These schemas may be processed by a specialized instance 206 of the generative response engine 110 configured to traverse stored conversation threads, application interaction logs, or system memory in order to generate structured, high-level natural language representations that reflect the specified categories.

A developer-directed schema may include elements, such as recurring communication topics, tone usage patterns, response latency characteristics, decision-making cues, or other personalized behaviors observed across the user's interaction history. The specialized instance may be fine-tuned to identify and abstract relevant information in accordance with the schema, producing either a natural language summary or structured representation suitable for downstream personalization.

For example, a developer of a productivity-focused email client may submit a schema instructing the system to: “Identify key personalization signals that could improve a user's experience with the email client, including communication themes, tone, timing patterns, and responsiveness.” In response, the output such as:
{“communication themes”: [“product feedback”, “hiring outreach”, “investor follow-ups”], “preferred tone”: “clear and direct”, “response timing”: “mornings, 8-10 am”, “decision behavior”: “high urgency, short turnaround”}.

In some embodiments, the system may support taxonomy-based schemas, wherein the developer defines a versioned classification system of signal types. These taxonomies may include domains such as productivity traits, emotional tone, topical interest, temporal behavior, or engagement style. The specialized instance 206 of the generative response engine 110 may then iterate over user interaction history, classifying data according to the provided taxonomy and returning signal representations in the form:
{“taxonomy version”: “v2.3”, “userId”: “user_8472”, “signals”: {“collaboration style”: “frequent summarization, deadline-conscious”, “communication tone”: “supportive but concise”, “frequent topics”: [“team updates”, “product planning”], “active windows”: [“weekdays, 7-11 am”] }}.

These structured outputs may be used by client applications to provide personalization, such as personalize user interfaces, reorder content, schedule proactive messages, or filter relevant data. The outputs may also be integrated with service logic to support adaptive workflows, notification logic, or recommendation models.

In addition to single-user representations, the context management service 120 may support aggregated signal synthesis across a population of users. In these cases, the specialized instance 206 of the generative response engine 110 may extract patterns across multiple user histories, returning cohort-level abstractions while omitting individual-level identifiers. For instance, a developer of a music streaming application may request aggregated representations describing how users express emotions when discussing favorite songs. The resulting output might include:
{“common descriptors”: [“haunting”, “energizing”, “nostalgic”], “emotion clusters”: [“uplifting”, “bittersweet”, “introspective”]}.

Such aggregated representations enable broader personalization strategies and interface optimizations based on population-level insights. By enabling schema-driven, developer-directed signal synthesis via specialized generative instances 206, the context management service 120 provides a privacy-conscious yet powerful mechanism for transforming historical interaction data into high-level, contextual representations that enhance personalization, user modeling, and service responsiveness.

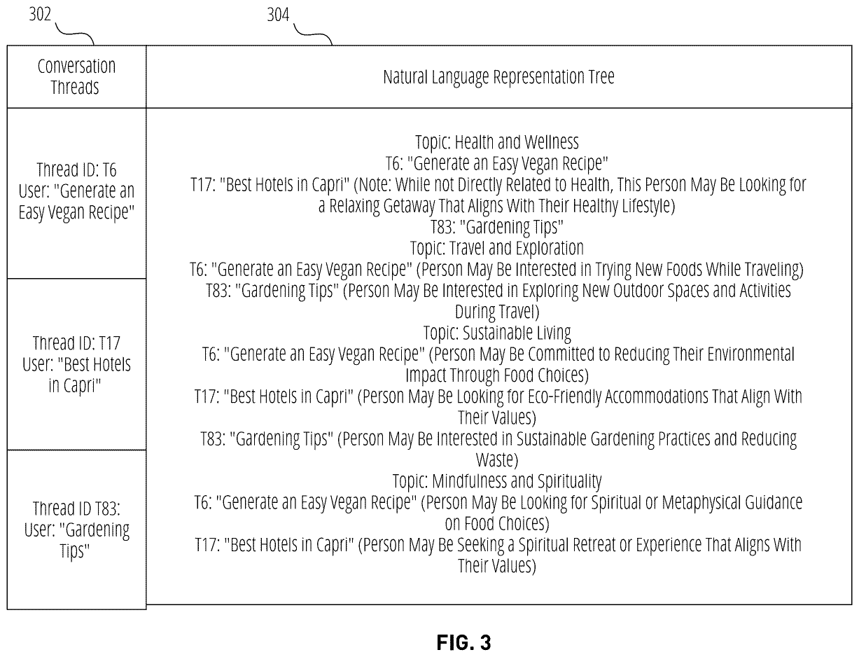

FIG. 3 is an example table that compares snippets from conversation threads in a natural language representation in accordance with some aspects of the present technology.

As illustrated in FIG. 3, a left-hand column displays snippets of conversation threads 302, specifically three conversational snippets with thread IDs of T6, T17, and T83 that were extracted from user interactions with the AI assistant service 100. These snippets represent prompts 124 issued by the user account, which hold significant value as they reveal crucial information about the user's preferences, interests, and intentions.

More specifically, prompts 124 are pivotal in providing insight into the user's characteristics, demographics, needs, preferences, and goals as they explicitly or implicitly convey their thoughts, questions, and concerns. By analyzing these prompts, the system can gain a deeper understanding of the user's personality, values, and behavior patterns, ultimately enabling more effective and personalized interactions with the AI assistant service.

In this context, the conversation snippets T6, T17, and T83 serve as tangible representations of the user's language patterns, tone, and style, allowing the system to refine its understanding of their preferences and adapt its responses accordingly. By integrating these insights, the generative response engine 110 can create a more accurate and comprehensive profile of the user, ultimately enhancing the overall quality of the interactions with a service provider or the AI assistant service 100.

A right-hand column presents an example natural language representation 304 that specifically calls out various categories/subcategories of user interest based on the conversation threads 302: Health and Wellness, Travel and Exploration, Sustainable Living, Mindfulness and Spirituality. The natural language representation 304 illustrates the relationship between each conversational snippet and its corresponding category of user interest. For example, T6 (Home Cook) appears under Health and Wellness, Sustainable Living, and Mindfulness and Spirituality, with notes indicating how the user may fit into these categories.

The generative response engine 110 may output the natural language representation in different forms. In some cases, the natural language representations may be in a tree form as shown in example natural language representation 304. In some cases, each tree topic may form a separate natural language representation.

In other cases, the natural language representations may be in paragraph form. As an example, the natural language representation may include: “It appears that this person is a health-conscious individual who values sustainability and relaxation. They're likely an urban dweller who spends most of their time indoors but enjoys exploring new outdoor spaces and trying new foods when they travel. This person may be particularly interested in eco-friendly accommodations and sustainable gardening practices, suggesting that they prioritize reducing their environmental impact in all areas of life. Their desire for easy vegan recipes suggests a strong commitment to healthy eating and self-care. Overall, this person seems like someone who is well-educated, confident, and values experiences that align with their high standards.” The natural language representation 202 may tap into a rich tapestry of connections between the various categories of user interest, demonstrating how individual conversational snippets can be woven together to form a nuanced portrait of the user's preferences and goals. Taking into account the user's interests in the multiple categories, the natural language representation 202 may be summarize and call out certain assumptions that is being made about the user. Through careful analysis of these connections and relationships, the natural language representation 202 can provide valuable insights into the user's underlying motivations and values.

When integrated with different services, the respective natural language representations may be altered to better reflect aspects pertaining to the respective service. For example, for a music service, based on the conversation snippets T6, T17, and T83, a comprehensive portrait of the user's music preferences may include the following as an example natural language representation: The user is likely drawn to relaxing music that promotes calmness and serenity, indicating an interest in genres like ambient or nature sounds. The user may enjoy creating a peaceful atmosphere for unwinding, such as during yoga practice, meditation, or simply as a way to de-stress. Moreover, the user may have a strong affinity for music that evokes a sense of wanderlust and adventure, which is characteristic of folk, world music, or instrumental soundtracks. The interest in exploration and travel implies that the user may enjoy music that sparks imagination and inspires new experiences. Perhaps they would appreciate playlists curated around their favorite travel destinations or scenic landscapes. In addition to these interests, we also infer that this user values music that promotes environmental awareness, conservation, or social justice. This suggests that they may be drawn to music that raises awareness about sustainability and eco-friendly living. As a result, we could recommend playlists featuring artists who advocate for environmental causes or produce music that highlights the importance of preserving our planet's natural resources.

Finally, we observe that this user is also interested in music that fosters mindfulness and spirituality. They may enjoy genres like sacred music, choral music, or instrumental music with a spiritual or philosophical theme. This interest in spiritual exploration suggests that they may appreciate music that inspires introspection, contemplation, or personal growth. For instance, we could suggest artists like Max Richter (ambient), Bon Iver (folk), or Ludovico Einaudi (sacred music) for their soothing and uplifting qualities. We may also recommend songs that align with the user's musical tastes, such as “River Flows in You” by Yiruma (instrumental music) or “Home” by Edward Sharpe & The Magnetic Zeros (folk-pop). As expected, this natural language representation is different from a natural language representation directed at a product recommendation service. Therefore, different natural language representations may be maintained and updated that represent the user account's different interests in consumption associated with the different services.

In some cases, the natural language representations may be derived from one or more generative response engines 110 provided by a generative response engine service provider. The synthesized memories may include portions of two or more conversation threads. For example, T6 and T83 may have been prompts sent to different generative response engines 110. As such, the natural language representations 202 may further include inferences, conclusions, connections, and/or relationships derived from the past conversation threads. As such, different instances of the same model version may be interacted with such that when different model versions are interacted with over time, the natural language representations 202 are retained.

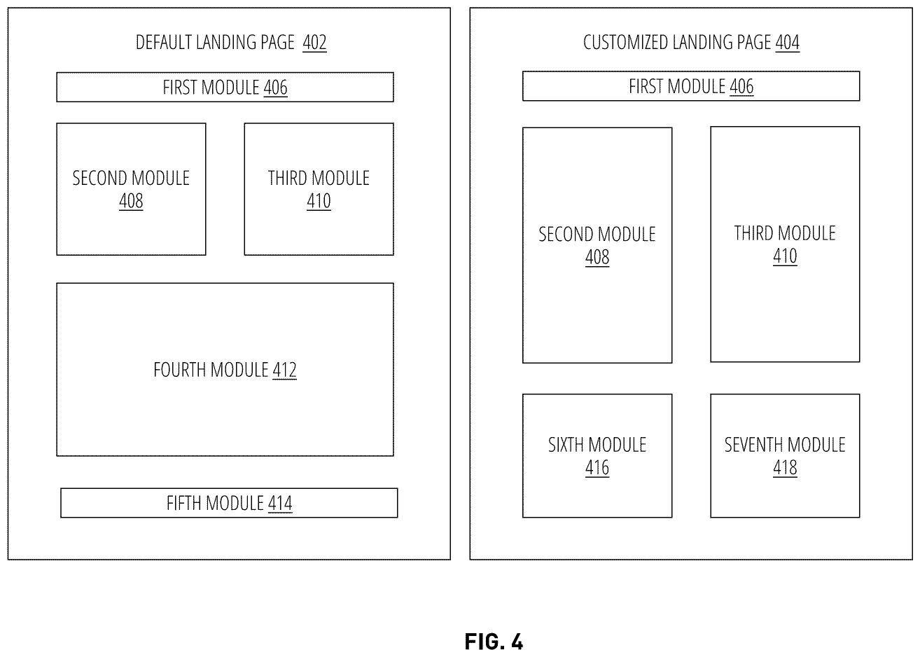

FIG. 4 illustrates an example landing page that uses a natural language representation of a user account for outputting customized recommendations in accordance with some aspects of the present technology.

The use of natural language representation can also make a user's experience better, whether it is a better landing page on a browser, or a customized page in an application or website that makes the application or website more usable to the user.

In some cases, an application may have a lot of features but the user only uses a few of the features. The AI assistant service 100 may send instructions to modify or directly modify code for a webpage or application to give a more simplified version that hides of the unused features in a menu. In some cases, the user can input their customization requests and natural language representations of their requests may be used to send instructions to modify or directly modify code for a webpage or application.

As shown in FIG. 4, a default landing page 402 may include a first module 406, a second module 408, a third module 410, a fourth module 412, and a fifth module 414. Either as the user continues to use the default landing page 402 and/or based on explicit customization requests by the user, the AI assistant service 100 may determine to change the default landing page 402 to a customized landing page 404.

The AI assistant service 100 may generate a natural language representation 202 based on the usage data of the default landing page 402 and/or based on explicit customization requests by the user. For example, the usage data and/or the explicit customization requests may indicate that the user uses the second module 408 and the third module 410 and consistently scrolling through those modules, referencing one part of the second module 408 and then scrolling to another part of the second module 408.

For example, if the default landing page 402 is for a news application. The natural language representation 202 may recite that “The user primarily utilizes the “Tech News” module and frequently scrolls through its sections, often referencing a specific sub-forum: “Tech New Releases”, while occasionally accessing the third module to “Global News” does stay to watch the videos. User does not use or look at the fourth module for “Local News” or the fifth module for “Investment Tips”.”

The natural language representation 202 may then be used to generate instructions for modifying or customizing the code for the webpage or application to reflect these usage patterns. For example, the AI assistant service 100 might use the natural language representation 202 to generate code that enlarges the second module 408 for the sub-forum for “Tech New Releases” and third module 410 for “Global News”, and change the access of the fourth module 412 and fifth module 414 to be through a menu or button, rather than having it visible by default since the user does not seem to use or look at those.

While these example changes are basic, it can be contemplated that the changes may be much more intricate. For example, the AI assistant service 100 may analyze the usage data on the default landing page 402 and/or elsewhere and generate dynamic content for one of the modules. As shown in FIG. 4, a new sixth module 416 and a new seventh module 418 may be added and may be completely new customized modules that is generated just for this user of the underlying application or service that is presenting the default landing page 402. For example, if the landing page is for an electronic trading platform and a user wants to compare two specific stocks in one chart but also have custom markers, one of the new modules may be generated based on a natural language representation that indicates that the user wants to compare two specific stocks in one chart in real-time and with the specific markers.

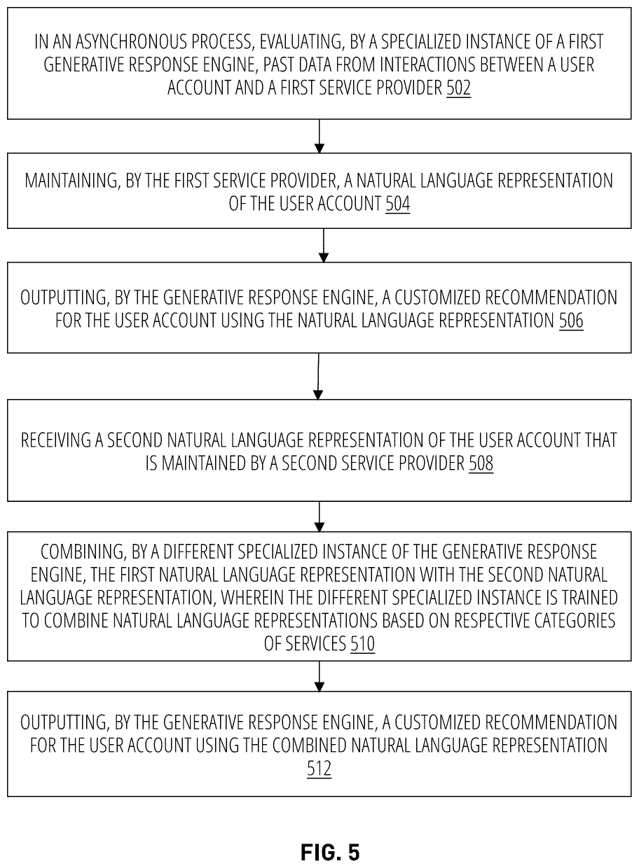

FIG. 5 illustrates an example method for providing a natural language representation of a user account for outputting customized recommendations in accordance with some aspects of the present technology. Although the example method depicts a particular sequence of operations, the sequence may be altered without departing from the scope of the present disclosure. For example, some of the operations depicted may be performed in parallel or in a different sequence that does not materially affect the function of the method. In other examples, different components of an example device or system that implements the method may perform functions at substantially the same time or in a specific sequence.

According to some examples, the method includes evaluating, by a specialized instance of a first generative response engine, past interaction data between a user account and a service provider at block 502. The evaluating may be in an asynchronous and/or offline process. For example, the specialized instance 206 and/or the generative response engine 110 of FIGS. 1 and 2 may evaluate the past interaction data. The specialized instance of the generative response engine 110 may be trained to determine what information is synthesized into the natural language representation of the user account. In some cases, the specialized instance of the generative response engine was trained to create the natural language representation that represents the user account's interest in consumption of a category of services associated with the service provider. In some cases, the specialized instance creates the natural language representation of the user account.

According to some examples, the method includes maintaining, by the service provider, a natural language representation of the user account at block 504. In some cases, the service provider has operational control over at least a part of the AI assistant service 100, including the context management service 120, the generative response engine 110, and/or the specialized instances. In some cases, the interaction data can be conversation threads for conversations between the user account and a chatbot of the service provider. In some cases, the interaction data can be summaries of visual data or interaction logs that describe the interactions of the user account with the service provider; this can be useful for extracting interaction data from interactions that are not language-based, and for extracting interaction data from interactions that are with interfaces other than a chatbot.

In some cases, the generative response engine may receive a prompt to output a customized recommendation. According to some examples, the method includes outputting, by the generative response engine, a customized recommendation for the user account using the natural language representation at block 506. For example, the generative response engine 1 10 may output the customized recommendation.

The interaction data can also be information about the consumption of products or services that is monitored or managed by the service provider. The service provider may be an advertisement service and the interaction data may include past interactions with ads that were placed by the advertisement service and may also include data from third-party sources regarding interactions, such as searches, emails, etc.

In some cases, the maintaining the natural language representation of the user account includes maintaining multiple natural language representations of the user account. For example, a first natural language representation of the multiple natural language representations may represent the user account's interest in consumption of a first category of services, and a second natural language representation of the multiple natural language representations represents the user account's interest in consumption of a second category of services. As such, the service provider may various services depending on what the prompt is.

In some cases, the first natural language representation with the second natural language representation may be combined. In some cases, a different specialized instance of the generative response engine may perform the combining and may be trained to combine natural language representations based on respective categories of services. For example, a user may request in the prompt for a recommendation for a recipe for her friend Stacy. One natural language representation may describe her friend Stacy based on a relationship management service and another natural language representation may represent the user's cooking skills and past dishes that they've made based on a recipe service. As such, the generative response engine may output a customized recommendation for the user account using the combined natural language representation.

According to some examples, the method includes receiving a second natural language representation of the user account that is maintained by a second service provider at block 508. The second service provider may be associated with a different generative response engine and/or AI assistant service 100. According to some examples, the method includes combining, by a different specialized instance of the generative response engine, the first natural language representation with the second natural language representation at block 510. The different specialized instance may be trained to combine natural language representations based on respective categories of services.

According to some examples, the method includes outputting, by the generative response engine, a customized recommendation for the user account using the combined natural language representation at block 512. For example, the generative response engine 110 and/or the AI assistant service 100 of FIG. 1 may output the customized recommendation.

In some cases, the service provider may schedule a prompt to be provided to the generative response engine to recommend a personalization of a service offered to the user account by the service provider. The prompt may include the natural language representation of the user account. For example, the service provider may be for an e-commerce platform and the scheduled prompt may be for a personalized weekly notification for all the upcoming sales that the user account may be interested in.

In some cases, the natural language representation can be accompanied by audio or visual representations of the user account. The audio or video representations may be generated based on at least the natural language representation, and in some cases, other data points that are associated with the user's behavior, preferences, and interests. For instance, a video that summarizes a user's preferences and interests may provide a concise overview of their tastes and values. The video could include visuals from their favorite movies, TV shows, or music videos, as well as images of places they've visited or want to visit. Alternatively, a brief audio clip that captures the user's voice tone, pitch, and cadence may be created for better personalized customer service or to create more engaging ads.

As another example, infographics or mood boards that illustrate key trends or insights about the user may provide a unique perspective on their interests and preferences. By leveraging video and audio content in this way, nuances of a users' preferences and interests may be captured more effectively for better personalized results.

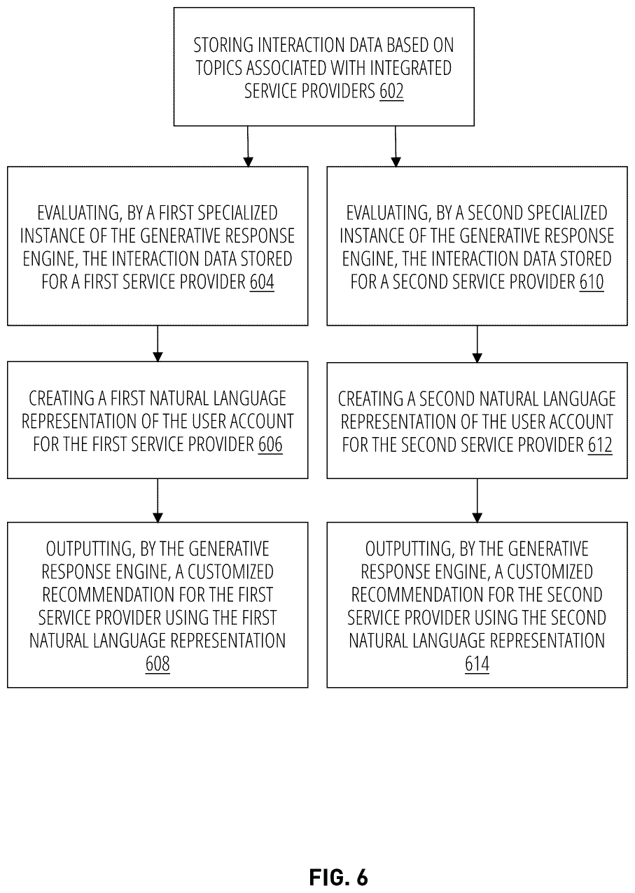

FIG. 6 illustrates an example method for providing a natural language representation of a user account for outputting customized recommendations in accordance with some aspects of the present technology. Although the example method depicts a particular sequence of operations, the sequence may be altered without departing from the scope of the present disclosure. For example, some of the operations depicted may be performed in parallel or in a different sequence that does not materially affect the function of the method. In other examples, different components of an example device or system that implements the method may perform functions at substantially the same time or in a specific sequence.

According to some examples, the method includes storing interaction data based on topics associated with service providers at block 602. In some cases, the AI assistant service 100 may store interaction data for service providers. The AI assistant service 100 may not be specifically tailored to support a particular service or application, but rather functions as a generalized assistant service. As such, the AI assistant service 100 has the potential to collect a vast amount of interaction data about the user account. The interaction data presents a valuable opportunity for service providers to leverage the insights gained from the AI assistant's conversations with users. By tapping into this data, service providers can unlock new opportunities for personalization, while also improving the overall user experience.

According to some examples, the method includes evaluating, by a first specialized instance of the generative response engine, the interaction data for a first service provider at block 604. The first specialized instance may be associated with the first service provider. As such, the first specialized instance may be uniquely tailored to the services provided by the first service provider, ensuring that the evaluation is performed in accordance with their specific requirements.

In some cases, the training of the specialized instance 206 may utilize Reinforcement Learning from Human Feedback (RLHF) that involves fine-tuning the language model using human feedback, rather than merely just relying on the original training data. Humans may provide ratings, preferences, or other signals to indicate whether the model's outputs are desirable or not. The generative response engine 110 may then be updated using reinforcement learning, adjusting the parameters to generate outputs that better align with the human feedback.

However, in some cases, end-to-end training using an objective may be employed, such as summarizing past interactions into a midterm working memory against the object of how useful the summarizations are. This approach allows the generative response engine 110 to learn from the cumulative effects of multiple interactions, refining its understanding of the user's preferences and behaviors over time. By leveraging both RLHF and end-to-end training methods, the generative response engine 110 can adapt to changing user needs and feedback, ultimately generating more accurate and effective responses that meet the user's evolving expectations.

In some cases, the natural language representation 202 is inserted into a context window 204. The context window 204 may be a finite space within which the generative response engine 110 processes and considers information provided in the prompt 124 and the natural language representation 202, taking into account preferences and relevant past conversations of the user account, as well as other relevant context.

In some cases, for evaluating the past conversation threads and creating the natural language representations 202, the specialized instance 206 analyzes the user's interactions with the AI assistant service 100, identifying patterns and trends, and generating abstracted representations of their experiences, thoughts, and feelings. In some cases, the specialized instance 206 performs the evaluation in an asynchronous, off-line process. Asynchronous means that the process can occur at any time and is not tied to any specific user interaction; when the system determines the process should be run, the process can be run. Off-line means that the process can be handled in a data center and does not require a live network connection nor is it tied to any user interaction.

The specialized instance 206 may use various techniques, such as natural language processing (NLP) and machine learning algorithms, to identify relevant information and generate cohesive and meaningful natural language representations 202. In some cases, the asynchronous evaluating of the past conversation threads is triggered after a threshold number of conversation threads have occurred that have not previously been evaluated.

In some cases, the specialized instance of the generative response engine may evaluate past interaction data between a user account and the service provider. In some cases, the specialized instance associated with the service provider may be trained to determine what information should be synthesized into the natural language representation of the user account. The data can be conversation threads for conversations between the user account and a chatbot of the service provider. In some cases, the data can be information about the user account's consumption of products or services provided by the service provider.

There are several interaction paradigms in which a service provider might interact with the generative response engine and make use of the natural language representation of a user account. In one example, service providers might access the generative response engine via an API, where the generative response engine has access to and maintains the different natural language representations for user accounts. These natural language representations might be identified by anonymous unique identifiers to anonymize the specific identity of the user account. In another example, the service providers might access the generative response engine via an API, where the service provider maintains the data and uses the generative response engine to generate and update the natural language representation and to output recommendations and insights in response to prompts provided by the service provider and taking into account the natural language representation of the user account. In yet another example, service providers might maintain the data and natural language representations, but the service providers can utilize the generative response engine (access via an API) to enhance the natural language representation of a user account based on other data from other service providers or from AI assistant service 100. In this example, there can be combined natural language representations.

While the above examples utilize APIs to interact with the generative response engine, the service providers could maintain their own instances of the generative response engine, or even have specialized and distilled versions of the generative response engine that run locally on a user device as part of an app or operating system.

For example, in a scenario where the AI assistant service 100 is interacting with users who are interested in booking flights. The interaction data collected from past conversations may be evaluated using the first specialized instance of the generative response engine, which may be specifically designed to analyze interaction data for the first specialized instance. For example, the first specialized instance may include customized algorithms and models that take into account the unique characteristics of flight-related searches and booking prompts, and determine what information is important in describing the user of the user account in way that is helpful for future bookings.

According to some examples, the method includes creating a first natural language representation of the user account for the first service provider at block 606. For example, the first specialized instance 206 and/or the generative response engine 110 in FIG. 1 and FIG. 2 may create the first natural language representation. According to some examples, the method includes outputting, by the generative response engine, a customized recommendation for the first service provider using the first natural language representation at block 608.

In some cases, the AI assistant service 100 may have a second specialized instance of the generative response engine that is associated with a second service provider. According to some examples, the method includes evaluating, by the second specialized instance of the generative response engine, the interaction data for the second service provider at block 610. According to some examples, the method includes creating a second natural language representation of the user account for the second service provider at block 612. For example, the first specialized instance 206 and/or the generative response engine 110 in FIG. 1 and FIG. 2 may evaluate and create the second natural language representation.

According to some examples, the method includes outputting, by the generative response engine, a customized recommendation for the second service provider using the second natural language representation at block 614. In some cases, the first specialized instance and the second specialized instance may evaluate the same conversations and determine different focuses and summaries for the respective natural language representation. The outputted custom recommendations may be sent to the respective service providers. In some cases, the service providers are integrated such that the customized recommendations may be used to generate actions. For example, booking recommendations may lead to generating a booking flow where the user can select one of the options of the booking recommendations that directly books hotels, flights, etc.

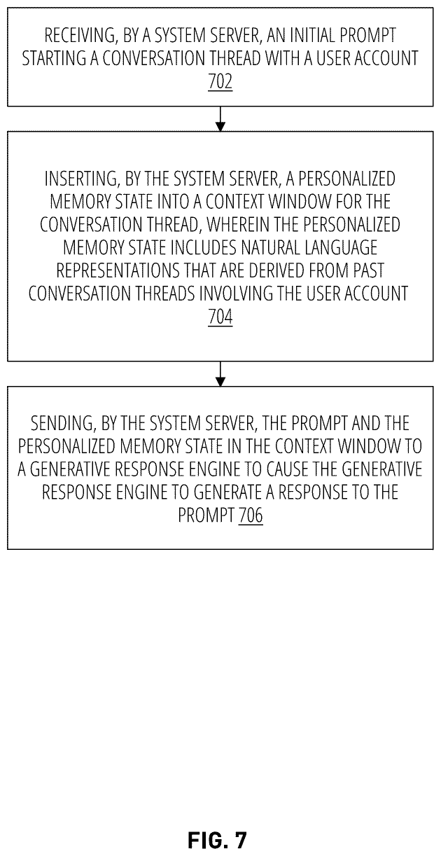

FIG. 7 illustrates an example method for context management for a generative response engine in accordance with some aspects of the present technology. Although the example method depicts a particular sequence of operations, the sequence may be altered without departing from the scope of the present disclosure. For example, some of the operations depicted may be performed in parallel or in a different sequence that does not materially affect the function of the method. In other examples, different components of an example device or system that implements the method may perform functions at substantially the same time or in a specific sequence.

According to some examples, the method includes receiving, by a system server, an initial prompt 124 starting a conversation thread with a user account at block 702. For example, the context management service 120 in FIG. 1 may embody the system server and may receive the initial prompt 124. The initial prompt 124 may include a natural language prompt, such as a typed prompt or a verbal prompt, code snippets, mathematical/scientific notations, media-based prompts, such as images, audio, or videos, embodied cognition prompts, such as multimodal inputs from various sensors or wearable devices, graph-based prompts, or any other type of inputs that a generative response engine 110, such as a large language model, can receive. For non-text based prompts, the provided media or multi-modal input may be described in natural language.

According to some examples, the method includes inserting, by the system server, a natural language representation 202 into a context window 204 for the conversation thread at block 704. For example, the context management service 120 in FIG. 1 may insert the natural language representation 202.

The context window 204 may be a finite space within which the system server processes and considers information provided in the prompt 124 and natural language representation 202, taking into account preferences and past conversations of the user account, as well as other relevant context.

According to some examples, the method includes sending, by the system server, the prompt 124 and the natural language representation 202 in the context window 204 to the generative response engine 110 at block 706. The generative response engine 110 may receive the prompt 124 and the natural language representation 202 to generate a response to the prompt 124. For example, the context management service 120 in FIG. 1 may send the prompt 124 and the natural language representation 202 in the context window 204 to the generative response engine 110. In some cases, the generative response engine 110 is trained to determine how or whether to utilize the natural language representation 202 when generating the response to the prompt 124.

For example, the generative response engine 110 may have been trained to determine whether to incorporate the entire natural language representation 202 into the response generation process or to selectively apply specific aspects of the natural language representation 202. As such the generative response engine 110 is trained to determine what parts of the natural language representation 202 are most relevant or useful in generating a coherent and accurate response. Furthermore, the generative response engine 110 may be optimized to balance the influence of the various features of the natural language representation 202, when determining how much weight to assign to various features of each. Lastly, in some cases, the generative response engine 110 may also be designed to override or modify suggestions from the natural language representation 202 in favor of other competing factors, such as fact-based knowledge about real-world events. This could involve incorporating external knowledge sources, using heuristics or rules-based systems, or employing additional machine learning techniques to improve the response.

In some cases, based on the prompt 124 and the natural language representation 202, the generative response engine 110 may determine to search an archive of past interactions between the user account and the generative response engine service provider. The archive of past interactions may include summaries of data such as the natural language representations 202. For example, a searchable index of the archive of past interactions may be created. The search about index may be based on conversation threads between the user account and the generative response engine service provider. The creation of the archive of past interactions may be achieved by first, creating searchable representations of at least portions of the conversation threads. The searchable representations may be chunks of text, audio, or video from the conversation threads, that are stored in the searchable index. The chunks may be vectors and subsets of the conversation threads, while the searchable index may be a vector database. The text chunks may overlap with adjacent text chunks from the same conversation thread.

In some cases, the searching may be performed using a file search tool that is designed to enable efficient search and retrieval operations. The file search tool may take in a collection of files and parses them into manageable chunks, embedding these chunks into a vector store. The vector store may provide precise search capabilities, making it easier to find specific information within the files. These parsed chunks may then indexed, facilitating the ability to provide contextually relevant responses. The generative response engine 110 may then access the index to generate answers that are pertinent to the user's query.

The file search tool may play a crucial role in accessing the archive of past interactions, which can be thought of as long-term memory. When a user engages with the AI assistant service 100, their conversation history is temporarily stored in short-term memory, allowing for seamless recall and response to subsequent queries. However, once the interaction has concluded or after a period of time, the relevant information is migrated from short-term memory to long-term memory, where it becomes part of the virtual assistant's vast knowledge repository. The archive of past interactions or long-term memory is distinguishable from the natural language representations 202 in that the long-term memory is all of the past interactions that have been archived.

The file search tool may service as a mechanism for retrieving the archive of past interactions. The file search tool essentially acts as a digital archive, enabling the AI assistant service 100 to draw upon its vast repository of past interactions to inform and improve future responses. In some cases, the file search tool can optimize parameters such as chunk size and overlap based on specific use cases. The file search tool may also generate the index with an index identifier, which enables easy identification by virtual assistants and convenient mapping of permission relationships between them and the indexes. This index may be a vector store, representing chunks of files or the entire file as vectors embedded with the meaning of these chunks. More information about how the file search tool may function is described in U.S. application Ser. No. 19/047,982, filed on Feb. 7, 2025, and titled “VIRTUAL ASSISTANTS API,” which is incorporated by reference herein.

In some cases, the generative response engine 110 may receive search results from the search of the archive of past interactions. The generative response engine 110 may generate the response to the prompt 124 from the context window 204 that includes at least the search results and the natural language representation 202. The generative response engine 110, such as the output validation engine 845, may be configured to determine whether the search results or contents of the natural language representation 202 are relevant for generating the response to the prompt 124. By learning to distinguish between essential and extraneous data, the generative response engine 110 may produce high-quality answers even when faced with superfluous information. The training process may involve exposing the generative response engine 110 to a wide range of inputs, including those that contain redundant or irrelevant data, and challenging it to identify what is truly relevant for generating an effective response.

For instance, consider the scenario where the prompt 124 is “What are the health benefits of eating blueberries?” The search results from past interactions may include a list of potential health benefits, as well as some unrelated information about the nutritional content of other fruits. In this case, the generative response engine 110 would need to determine which pieces of information are relevant for answering the user's question. To achieve this, the generative response engine 110 may be trained on a dataset that includes examples like “The search results for ‘health benefits of blueberries’ include: high in antioxidants, may help lower blood pressure. However, we also found some unrelated information about strawberries being rich in vitamin C.” The model learns to recognize that only certain pieces of information are directly relevant to answering the user's question. The training process may involve a combination of supervised learning, where the generative response engine 110 is labeled with correct answers to specific questions, and unsupervised learning, where it learns patterns and relationships in large datasets.

In some cases, after receiving the initial prompt 124 and the natural language representation 202, the generative response engine 110 may review contents of the context window 204 and determine to remove portions, such as irrelevant portions, of the natural language representation 202 from the context window 204. In some cases, the generative response engine 110 may determine to summarize at least a portion of the natural language representation 202 in the context window to yield at least a shortened portion of the natural language representation 202. By summarizing, more room may be made available in the context window 204.

The generative response engine 110 may be trained to review the context window 204 to determine that portions of the natural language representations 202 are not relevant to the thread and should be removed. In some cases, the reviewing may be limited to when the context window 204 is reaching capacity and there is a need to make room to add other relevant data, such as from searching the archive of past interactions or past conversations.

In some cases, the specialized instance 206 of the generative response engine 110 may revise, add, or remove parts of the natural language representations 202 in a subsequent occurrence. In some cases, the subsequent occurrence is subsequent to the asynchronous evaluation the past conversation thread. For example, if a user revisits an earlier conversation topic or introduces new information, the specialized instance 206 may update its existing natural language representations 202 to reflect such changes. The revision process may also enables the specialized instance 206 to learn from user feedback and preferences, refining its generation of natural language representations 202. In other cases, the specialized instance 206 may use the revised memories to inform subsequent interactions with the AI assistant service 100.

The revision process may be analogous to how brains process and retain memories: just as connections in the brain can be strengthened or weakened over time, the natural language representations 202 can be updated, modified, or removed based on new information and user interactions. Similarly, the revised memories can serve as a kind of ‘mental anchor’ that helps the specialized instance 212 recall relevant information from past conversations. As such, the revision process is akin to how brains can be prompted to remember past thoughts or experiences through various means, such as recalling similar contexts or emotions. In some cases, as a results of the revision of the natural language representations 202, a summary of the at least one topic that was previously part of the natural language representations may be removed. As a result, the removed summary may be moved into an archive of past interactions for later search and retrieval.

In some cases, the specialized instance 206 of the generative response engine 110 may determine that the past conversation threads indicate at least two distinct usage profiles of the generative response engine 110 by the user account. As such, the creation of the natural language representations 202 may includes creating at least a first set of natural language representations 202 and a second set of natural language representations 202, where the first set of natural language representations 202 correspond to a first distinct usage profile, and the second set of natural language representations 202 that correspond to the second distinct usage profile. For example, the first distinct usage profile pertains to business conversation threads, wherein the second distinct usage profile pertains to a personal conversation threads.

When there are different sets of natural language representations 202 present, the natural language representation 202 may include separate summaries for the different sets of natural language representations 202. In some cases, based the prompt 124 and the summary of the first set of the natural language representations 202 and the summary of the second set of the natural language representations 202, the generative response engine 110 may determine that the first set of natural language representations 202 is more related to the prompt 124. As such, the generative response engine 110 may retrieve the first set of natural language representations 202 to be included in the context window 204 to be referenced while responding to the prompt 124.

In some cases, the generative response engine 110 may reason over the prompt 124 and the natural language representation 202 about whether portions of the natural language representation 202 are relevant to the prompt 124 and should be used in generating the response to the prompt. The reasoning may be performed by a reasoning model of the generative response engine. The reasoning model may output a chain of thought and use the chain of thought to guide an inference operation and creation of the final output.

The reasoning may involve evaluating the semantic similarity between the prompt and each portion of the personalized memory state, and selecting only those portions that are most relevant to the task at hand. This may involve using various inference rules or heuristics to guide the reasoning process, such as identifying keywords or entities mentioned in both the prompt and the personalized memory state. The reasoning model may output a chain of thought that represents the selected portion of the personalized memory state, which is then used to guide an inference operation to generate the final response. This final output may be a rewritten version of the original prompt, with additional information or context added based on the inferences made from the personalized memory state.

For example, if the prompt is “What's the latest news on [topic]?”, the generative response engine 110 might identify a relevant portion of the personalized memory state that mentions a similar topic, and use this to guide an inference operation to generate a response.

The reasoning model may output a chain of thought that represents the selected portion of the personalized memory state, which is then used to guide an inference operation to generate the final response. The final output may be a rewritten version of the original prompt, with additional information or context added based on the inferences made from the personalized memory state. This can include adding relevant details, examples, or analogies to help illustrate the response and make it more engaging for the user. In some cases, the generative response engine may also use the chain of thought output by the reasoning model to generate a summary or overview of the relevant information in the personalized memory state. This can be particularly useful when generating responses that require summarizing large amounts of data or extracting key insights from a complex conversation history.

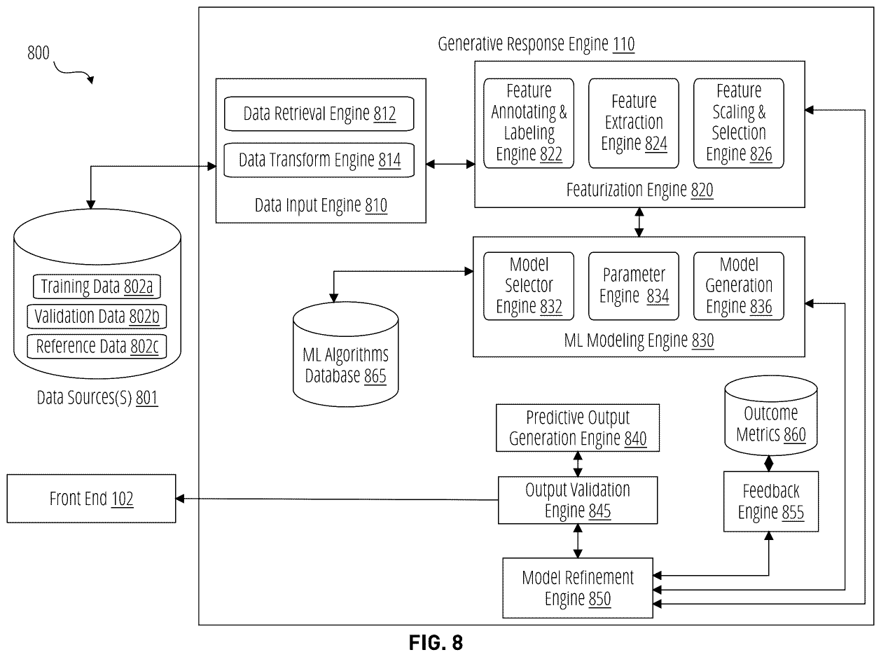

FIG. 8 is a block diagram illustrating an example machine learning platform for implementing various aspects of this disclosure in accordance with some aspects of the present technology. Although the example system depicts particular system components and an arrangement of such components, this depiction is to facilitate a discussion of the present technology and should not be considered limiting unless specified in the appended claims. For example, some components that are illustrated as separate can be combined with other components, and some components can be divided into separate components.

System 800 may include data input engine 810 that can further include data retrieval engine 812 and data transform engine 814. Data retrieval engine 812 may be configured to access, interpret, request, or receive data, which may be adjusted, reformatted, or changed (e.g., to be interpretable by another engine, such as data input engine 810). For example, data retrieval engine 812 may request data from a remote source using an API. Data input engine 810 may be configured to access, interpret, request, format, re-format, or receive input data from data sources(s) 801. For example, data input engine 810 may be configured to use data transform engine 814 to execute a re-configuration or other change to data, such as a data dimension reduction. In some aspects, data sources(s) 801 may be associated with a single entity (e.g., organization) or with multiple entities. Data sources(s) 801 may include one or more of training data 802a (e.g., input data to feed a machine learning model as part of one or more training processes), validation data 802b (e.g., data against which at least one processor may compare model output with, such as to determine model output quality), and/or reference data 802c. In some aspects, data input engine 810 can be implemented using at least one computing device. For example, data from data sources(s) 801 can be obtained through one or more I/O devices and/or network interfaces. Further, the data may be stored (e.g., during execution of one or more operations) in a suitable storage or system memory. Data input engine 810 may also be configured to interact with a data storage, which may be implemented on a computing device that stores data in storage or system memory.

System 800 may include featurization engine 820. Featurization engine 820 may include feature annotating & labeling engine 822 (e.g., configured to annotate or label features from a model or data, which may be extracted by feature extraction engine 824), feature extraction engine 824 (e.g., configured to extract one or more features from a model or data), and/or feature scaling & selection engine 826 Feature scaling & selection engine 826 may be configured to determine, select, limit, constrain, concatenate, or define features (e.g., AI features) for use with AI models.

System 800 may also include machine learning (ML) ML modeling engine 830, which may be configured to execute one or more operations on a machine learning model (e.g., model training, model re-configuration, model validation, model testing), such as those described in the processes described herein. For example, ML modeling engine 830 may execute an operation to train a machine learning model, such as adding, removing, or modifying a model parameter. Training of a machine learning model may be supervised, semi-supervised, or unsupervised. In some aspects, training of a machine learning model may include multiple epochs, or passes of data (e.g., training data 802a) through a machine learning model process (e.g., a training process). In some aspects, different epochs may have different degrees of supervision (e.g., supervised, semi-supervised, or unsupervised). Data into a model to train the model may include input data (e.g., as described above) and/or data previously output from a model (e.g., forming a recursive learning feedback). A model parameter may include one or more of a seed value, a model node, a model layer, an algorithm, a function, a model connection (e.g., between other model parameters or between models), a model constraint, or any other digital component influencing the output of a model. A model connection may include or represent a relationship between model parameters and/or models, which may be dependent or interdependent, hierarchical, and/or static or dynamic. The combination and configuration of the model parameters and relationships between model parameters discussed herein are cognitively infeasible for the human mind to maintain or use. Without limiting the disclosed aspects in any way, a machine learning model may include millions, billions, or even trillions of model parameters. ML modeling engine 830 may include model selector engine 832 (e.g., configured to select a model from among a plurality of models, such as based on input data), parameter engine 834 (e.g., configured to add, remove, and/or change one or more parameters of a model), and/or model generation engine 836 (e.g., configured to generate one or more machine learning models, such as according to model input data, model output data, comparison data, and/or validation data).

In some aspects, model selector engine 832 may be configured to receive input and/or transmit output to ML algorithms database 865. Similarly, featurization engine 820 can utilize storage or system memory for storing data and can utilize one or more I/O devices or network interfaces for transmitting or receiving data. ML algorithms database 865 may store one or more machine learning models, any of which may be fully trained, partially trained, or untrained. A machine learning model may be or include, without limitation, one or more of (e.g., such as in the case of a metamodel) a statistical model, an algorithm, a neural network (NN), a convolutional neural network (CNN), a generative neural network (GNN), a Word2Vec model, a bag of words model, a term frequency-inverse document frequency (tf-idf) model, a GPT (Generative Pre-trained Transformer) model (or other autoregressive model), a diffusion model, a diffusion-transformer model, an encoder such as BERT (Bidirectional Encoder Representations from Transformers) or LXMERT (Learning Cross-Modality Encoder Representations from Transformers), a Proximal Policy Optimization (PPO) model, a nearest neighbor model (e.g., k nearest neighbor model), a linear regression model, a k-means clustering model, a Q-Learning model, a Temporal Difference (TD) model, a Deep Adversarial Network model, or any other type of model described further herein. Some of the ML algorithms in ML algorithms database 865 can be considered generative response engines. Generative response engines are those models are commonly referred to as Generative AI, and that can receive an input prompt and generate additional content based on the prompt. GPTs, diffusion models, and diffusion-transformer models are some non-limiting examples of generative response engines. Some specific examples of generative response engines that can be stored in the ML algorithms database 865 include versions DALLE, CHAT GPT, and SORA, all provided by OPEN AI.

System 800 can further include predictive output generation engine 840 and output validation engine 845 (e.g., configured to apply validation data to machine learning model output). Predictive output generation engine 840 can analyze the input and identify relevant patterns and associations in the data it has learned to generate a sequence of words that predictive output generation engine 840 predicts is the most likely continuation of the input using one or more models from the ML algorithms database 865, aiming to provide a coherent and contextually relevant answer. Predictive output generation engine 840 generates responses by sampling from the probability distribution of possible words and sequences, guided by the patterns observed during its training. In some aspects, predictive output generation engine 840 can generate multiple possible responses before presenting the final one. Predictive output generation engine 840 can generate multiple responses based on the input, and these responses are variations that predictive output generation engine 840 considers potentially relevant and coherent. Output validation engine 845 can evaluate these generated responses based on certain criteria. These criteria can include relevance to the prompt, coherence, fluency, and sometimes adherence to specific guidelines or rules, depending on the application. Based on this evaluation, output validation engine 845 selects the most appropriate response. This selection is typically the one that scores highest on the set criteria, balancing factors like relevance, informativeness, and coherence. The most appropriate response may be sent to the front end 102 (e.g., front end 102). In some cases the generative response engine 110 includes the predictive output generation engine 840 and the output validation engine 845.

System 800 can further include feedback engine 855 (e.g., configured to apply feedback from a user and/or machine to a model) and model refinement engine 850 (e.g., configured to update or re-configure a model). In some aspects, feedback engine 855 may receive input and/or transmit output (e.g., output from a trained, partially trained, or untrained model) to outcome metrics database 860. Outcome metrics database 860 may be configured to store output from one or more models and may also be configured to associate output with one or more models. In some aspects, outcome metrics database 860, or other device (e.g., model refinement engine 850 or feedback engine 855), may be configured to correlate output, detect trends in output data, and/or infer a change to input or model parameters to cause a particular model output or type of model output. In some aspects, model refinement engine 850 may receive output from predictive output generation engine 840 or output validation engine 845. In some aspects, model refinement engine 850 may transmit the received output to featurization engine 820 or ML modeling engine 830 in one or more iterative cycles.

In some cases, data input engine 810, featurization engine 820, ML modeling engine 830, predictive output generation engine 840, output validation engine 845, model refinement engine 850, feedback engine 855, outcome metrics database 860 are a part of generative response engine 110. It is to be understood that the generative response engine 110 may include some or all of these components, and/or additional components not listed here. Furthermore, certain components may be located in other modules or systems within the overall system architecture. The generative response engine 110 may also include additional functionality not described herein, and certain components may be integrated into other modules or systems within the overall AI assistant service 100. In addition, it is to be understood that the generative response engine 110 can be modified, replaced, or augmented with additional components or functionality as needed to achieve specific performance or functional requirements.

The engines of system 800 may be packaged functional hardware units designed for use with other components or a part of a program that performs a particular function (e.g., of related functions). Any or each of these modules may be implemented using a computing device. In some aspects, the functionality of system 800 may be split across multiple computing devices to allow for distributed processing of the data, which may improve output speed and reduce computational load on individual devices. In some aspects, system 800 may use load-balancing to maintain stable resource load (e.g., processing load, memory load, or bandwidth load) across multiple computing devices and to reduce the risk of a computing device or connection becoming overloaded. In these or other aspects, the different components may communicate over one or more I/O devices and/or network interfaces.

System 800 can be related to different domains or fields of use. Descriptions of aspects related to specific domains, such as natural language processing or language modeling, is not intended to limit the disclosed aspects to those specific domains, and aspects consistent with the present disclosure can apply to any domain that utilizes predictive modeling based on available data.

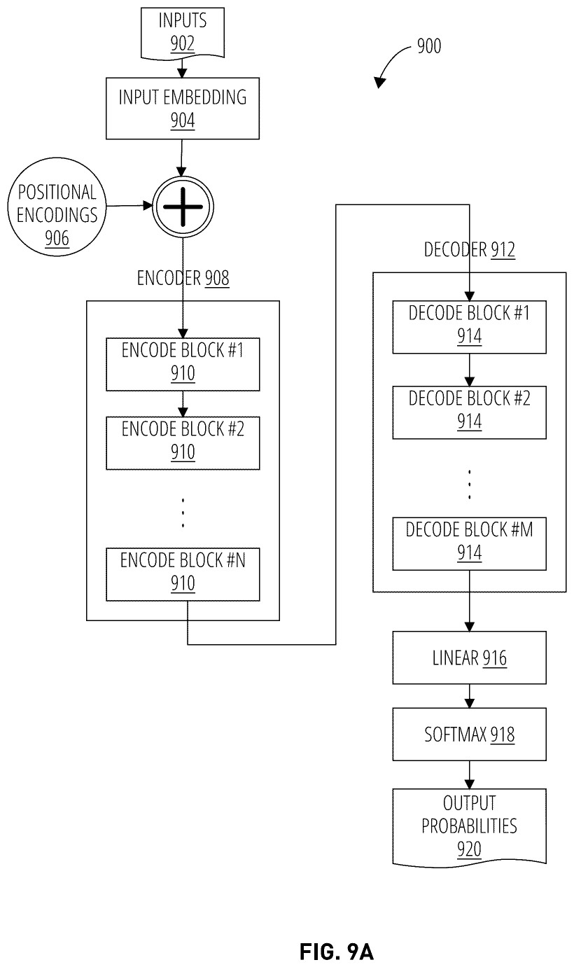

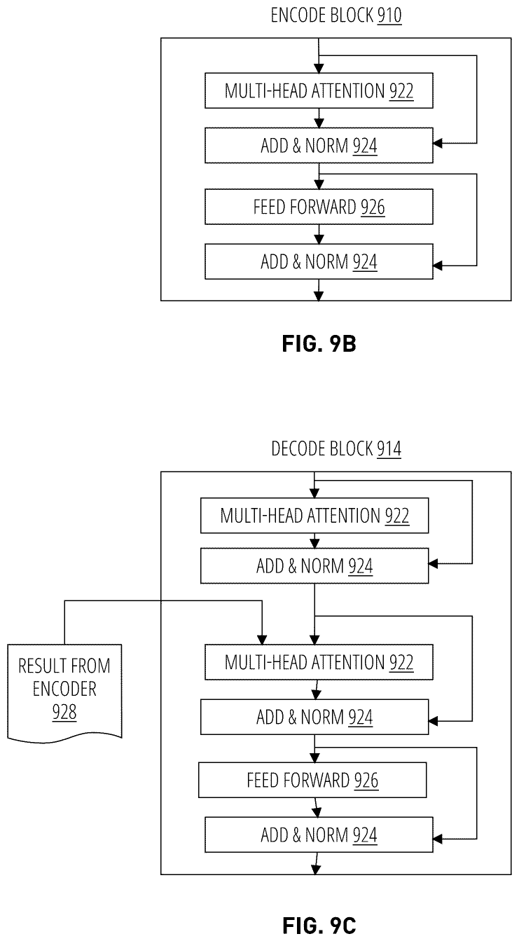

FIG. 9A, FIG. 9B, and FIG. 9C illustrates an example transformer architecture in accordance with some aspects of the present technology. Examples of ML models that use a transformer neural network (e.g., transformer architecture 900) can include, e.g., generative pretrained transformer (GPT) models and Bidirectional Encoder Representations from Transformer (BERT) models. The transformer architecture 900, which is illustrated in FIG. 9A, FIG. 9B, and FIG. 9C, includes inputs 902, input embedding block 904, positional encodings 906, encoder 908 including encode blocks 910, decoder 912 including decode blocks 914, linear block 916, softmax block 918, and output probabilities 920.

Input embedding block 904 is used to provide representations for words. For example, embedding can be used in text analysis. According to certain non-limiting examples, the representation is a real-valued vector that encodes the meaning of the word in such a way that words that are closer in the vector space are expected to be similar in meaning. Word embeddings can be obtained using language modeling and feature learning techniques, where words or phrases from the vocabulary are mapped to vectors of real numbers. According to certain non-limiting examples, the input embedding block 904 can be learned embeddings to convert the input tokens and output tokens to vectors of dimension that have the same dimension as the positional encodings, for example.

Positional encodings 906 provide information about the relative or absolute position of the tokens in the sequence. According to certain non-limiting examples, positional encodings 906 can be provided by adding positional encodings to the input embeddings at the inputs to the encoder 908 and decoder 912. The positional encodings have the same dimension as the embeddings, thereby enabling a summing of the embeddings with the positional encodings. There are several ways to realize the positional encodings, including learned and fixed. For example, sine and cosine functions having different frequencies can be used. That is, each dimension of the positional encoding corresponds to a sinusoid. Other techniques of conveying positional information can also be used, as would be understood by a person of ordinary skill in the art. For example, learned positional embeddings can instead be used to obtain similar results. An advantage of using sinusoidal positional encodings rather than learned positional encodings is that doing so allows the model to extrapolate to sequence lengths longer than the ones encountered during training.

Encoder 908 can use stacked self-attention and point-wise, fully connected layers. Encoder 908 can be a stack of N identical layers (e.g., N=6), and each layer can be an encode block, as illustrated by encode block 910 shown in FIG. 9B. Each encode block 910 has two sub-layers: (i) a first sub-layer has a multi-head attention block 922 and (ii) a second sub-layer has a feed forward block 926, which can be a position-wise fully connected feed-forward network. The feed forward block 926 can use a rectified linear unit (ReLU).

Encoder 908 uses a residual connection around each of the two sub-layers, followed by an add & norm block 924, which performs normalization. For example, the output of each sub-layer can be LayerNorm(x+Sublayer(x)). To facilitate these residual connections, all sub-layers in the model, as well as the embedding layers, produce output data having a same dimension.

Similar to encoder 908, decoder 912 uses stacked self-attention and point-wise, fully connected layers. Decoder 912 can also be a stack of M identical layers (e.g., M=6), and each layer can be a decode block, as illustrated by decode block 912 shown in FIG. 9B. In addition to the two sub-layers (i.e., the sublayer with multi-head attention block 922 and the sub-layer with feed forward block 926) found in encode block 910, decode block 914 can include a third sub-layer, which performs multi-head attention over the output of the encoder stack. Similar to encoder 908, decoder 912 uses residual connections around each of the sub-layers, followed by layer normalization. Additionally, the sub-layer with multi-head attention block 922 can be modified in the decoder stack to prevent positions from attending to subsequent positions. This masking, combined with the fact that the output embeddings are offset by one position, can ensure that the predictions for position i can depend only on the known output data at positions less than i.

Linear block 916 can be a learned linear transformation. For example, when transformer architecture 900 is being used to translate from a first language into a second language, linear block 916 can project the output from the last decode softmax block 918 into word scores for the second language (e.g., a score value for each unique word in the target vocabulary) at each position in the sentence. For instance, if the output sentence has seven words and the provided vocabulary for the second language has 10,000 unique words, then 10,000 score values are generated for each of those seven words. The score values indicate the likelihood of occurrence for each word in the vocabulary in that position of the sentence.

Softmax block 918 then turns the scores from linear block 916 into output probabilities 920 (which add up to 1.0). In each position, the index provides for the word with the highest probability, and then maps that index to the corresponding word in the vocabulary. Those words then form the output sequence of transformer architecture 900. The softmax operation is applied to the output from linear block 916 to convert the raw numbers into output probabilities 920 (e.g., token probabilities).

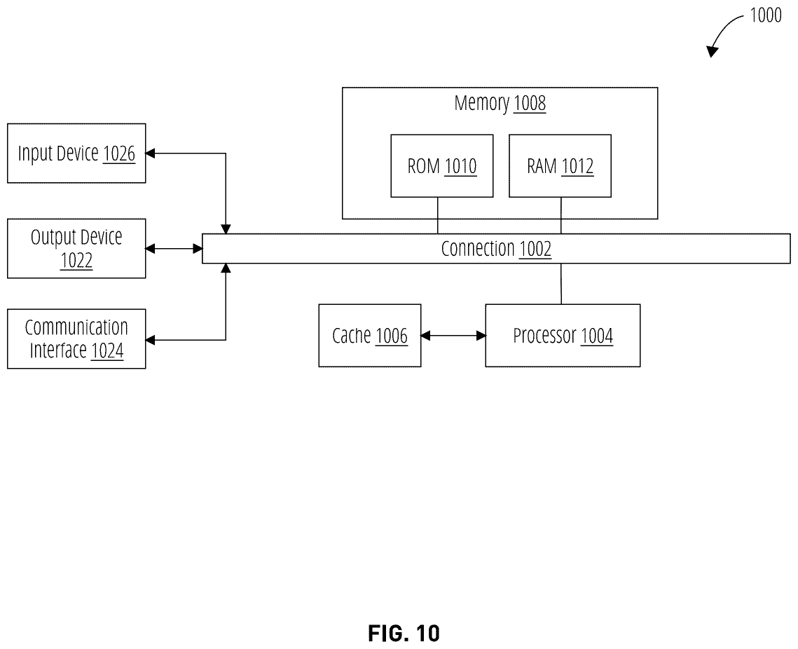

FIG. 10 shows an example of computing system 1000, which can be, For example, any computing device making up any engine illustrated in FIG. 1 and FIG. 2 or any component thereof.

In some aspects, computing system 1000 is a single device, or a distributed system in which the functions described in this disclosure can be distributed within a datacenter, multiple data centers, a peer network, etc. In some aspects, one or more of the described system components represents many such components each performing some or all of the function for which the component is described. In some aspects, the components can be physical or virtual devices.

In some aspects, computing system 1000 may comprise one or more computing resources provisioned from a “cloud computing” provider, For example, AMAZON ELASTIC COMPUTE CLOUD (“AMAZON EC2”), provided by AMAZON, INC. of Seattle, Washington; SUN CLOUD COMPUTER UTILITY, provided by SUN MICROSYSTEMS, INC. of Santa Clara, California; AZURE, provided by MICROSOFT CORPORATION of Redmond, Washington, GOOGLE CLOUD PLATFORM, provided by ALPHABET, INC. of Mountain View, California, and the like.

Example computing system 1000 includes at least one processing unit (CPU or processor) 1004 and connection 1002 that couples various system components including system memory 1008, such as read-only memory (ROM) 1010 and random access memory (RAM) 1012 to processor 1004. Memory 1008 can be a volatile or non-volatile memory device, and can be a hard disk or other types of non-transitory computer readable media which can store data that are accessible by a computer, such as magnetic cassettes, flash memory cards, solid state memory devices, digital versatile disks, cartridges, random access memories (RAMs), read-only memory (ROM), and/or some combination of these devices.

Memory 1008 can include software services, servers, logic, etc., that when the code that defines such software is executed by the processor 1004, it causes the system to perform a function. In some aspects, a hardware service that performs a particular function can include the software component stored in a computer-readable medium in connection with the necessary hardware components, such as processor 1004, connection 1002, output device 1022, etc., to carry out the function.

Computing system 1000 can include a cache of high-speed memory 1006 connected directly with, in close proximity to, or integrated as part of processor 1004.

Connection 1002 can be a physical connection via a bus, or a direct connection into processor 1004, such as in a chipset architecture. Connection 1002 can also be a virtual connection, networked connection, or logical connection.

Processor 1004 can include any general purpose processor and a hardware service or software service stored in memory 1008, configured to control processor 1004 as well as a special-purpose processor where software instructions are incorporated into the actual processor design. Processor 1004 may essentially be a completely self-contained computing system, containing multiple cores or processors, a bus, memory controller, cache, etc. A multi-core processor may be symmetric or asymmetric. Processor 1004 can be physical or virtual.

To enable user interaction, computing system 1000 includes an input device 1026, which can represent any number of input mechanisms, such as a microphone for speech, a touch-sensitive screen for gesture or graphical input, keyboard, mouse, motion input, speech, etc. Computing system 1000 can also include output device 1022, which can be one or more of a number of output mechanisms known to those of skill in the art. In some instances, multimodal systems can enable a user to provide multiple types of input/output to communicate with computing system 1000. Computing system 1000 can include communication interface 1024, which can generally govern and manage the user input and system output. There is no restriction on operating on any particular hardware arrangement, and therefore the basic features here may easily be substituted for improved hardware or firmware arrangements as they are developed.

In some aspects, computing system 1000 can refer to a combination of a personal computing device interacting with components hosted in a data center, where both the computing device and the components in the data center. In such examples, both the personal computing device and the components in the datacenter might have a processor, cache, memory, storage, etc.

For clarity of explanation, in some instances, the present technology may be presented as including individual functional blocks including functional blocks comprising devices, device components, steps or methods in a method embodied in software, or combinations of hardware and software.

Any of the steps, operations, functions, or processes described herein may be performed or implemented by a combination of hardware and software services or services, alone or in combination with other devices. In some aspects, a service can be software that resides in memory of a client device and/or one or more servers of the AI assistant service and perform one or more functions when a processor executes the software associated with the service. In some aspects, a service is a program or a collection of programs that carry out a specific function. In some aspects, a service can be considered a server. The memory can be a non-transitory computer-readable medium.

In some aspects, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer-readable media. Such instructions can comprise, For example, instructions and data which cause or otherwise configure a general purpose computer, special purpose computer, or special purpose processing device to perform a certain function or group of functions. Portions of computer resources used can be accessible over a network. The executable computer instructions may be, For example, binaries, intermediate format instructions such as assembly language, firmware, or source code. Examples of computer-readable media that may be used to store instructions, information used, and/or information created during methods according to described examples include magnetic or optical disks, solid-state memory devices, flash memory, USB devices provided with non-volatile memory, networked storage devices, and so on.

Devices implementing methods according to these disclosures can comprise hardware, firmware and/or software, and can take any of a variety of form factors. Typical examples of such form factors include servers, laptops, smartphones, small form factor personal computers, personal digital assistants, and so on. The functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

### Aspects

The present technology includes computer-readable storage mediums for storing instructions, and systems for executing any one of the methods embodied in the instructions addressed in the aspects of the present technology presented below:

Aspect 1: . . . FILL THIS OUT WHEN THE CLAIMS ARE FINALIZED

The present technology includes computer-readable storage mediums for storing instructions, and systems for executing any one of the methods embodied in the instructions addressed in the aspects of the present technology presented below:

What is claimed is:

1. A method comprising:
in an asynchronous process, evaluating, by a generative response engine, past interaction data between a user account and a service provider, wherein the generative response engine is configured to determine what information should be synthesized into a natural language representation of the user account;
creating the natural language representation of the user account;
maintaining the natural language representation of the user account; and
outputting, by the generative response engine, a customized recommendation for the user account using the natural language representation.

2. The method of claim 1, wherein the generative response engine was trained to create the natural language representation that represents an interest of the user account in consumption of a category of services associated with the service provider.

3. The method of claim 1, wherein the maintaining the natural language representation of the user account includes maintaining multiple natural language representations of the user account, wherein a first natural language representation of the multiple natural language representations represents an interest of the user account in consumption of a first category of services, and wherein a second natural language representation of the multiple natural language representations represents an interest of the user account in consumption of a second category of services.

4. The method of claim 3, further comprising:
combining the first natural language representation with the second natural language representation; and
outputting, by the generative response engine, a customized combined recommendation for the user account using the combined natural language representation.

5. The method of claim 1, further comprising:
receiving a different natural language representation of the user account that is maintained by a different service provider;
combining the natural language representation with the different natural language representation; and
outputting, by the generative response engine, a customized combined recommendation for the user account using the combined natural language representation.

6. The method of claim 1, further comprising:
receiving, by the generative response engine, a prompt to output the customized recommendation for the user account.

7. The method of claim 1, further comprising:
scheduling, by the service provider, a prompt to be provided to the generative response engine to recommend a personalization of a service offered to the user account by the service provider, wherein the prompt includes the natural language representation of the user account.

8. The method of claim 1, wherein the natural language representation can be accompanied by audio or visual representations of the user account.

9. A computing system comprising:
one or more processors; and
one or more memory storing instructions that, when executed by the one or more processors, configure the computing system to:
in an asynchronous process, evaluate, by a generative response engine, past interaction data between a user account and a service provider, wherein the generative response engine is configured to determine what information should be synthesized into a natural language representation of the user account;
create the natural language representation of the user account;
maintain the natural language representation of the user account; and
output, by the generative response engine, a customized recommendation for the user account using the natural language representation.

10. The computing system of claim 9, wherein the instructions further configure the computing system to:
storing interaction data based on topics associated with service providers including the first service provider;
in an asynchronous process, evaluating, by the first specialized instance of the generative response engine, the interaction data stored for the first service provider, wherein the first specialized instance of the generative response engine is trained to determine what information should be synthesized into the first natural language representation of the user account; and
creating the first natural language representation of the user account.

11. The computing system of claim 10, wherein the first specialized instance of the generative response engine was trained to create the first natural language representation that represents an interest of the user account in consumption of a first category of services.

12. The computing system of claim 11, wherein the instructions further configure the computing system to:
maintaining, by a second specialized instance of the generative response engine, a second natural language representation of the user account for a second service provider; and
outputting, by the generative response engine, a second customized recommendation for the user account using the second natural language representation.

13. The computing system of claim 12, wherein the service providers include the second service provider, and wherein the instructions further configure the computing system to:
in a different asynchronous process, evaluating, by the second specialized instance of the generative response engine, the interaction data indexed for the second service provider, wherein the second specialized instance of the generative response engine is trained to determine what information should be synthesized into the second natural language representation of the user account; and
creating the second natural language representation of the user account.

14. The computing system of claim 13, wherein the first specialized instance of the generative response engine was trained to create the first natural language representation that represents an interest of the user account in consumption of a first category of services, and wherein the second specialized instance of the generative response engine was trained to create the second natural language representation that represents an interest of the user account in consumption of a second category of services.

15. The computing system of claim 12, wherein the instructions further configure the computing system to:
combining, by a third specialized instance of the generative response engine, the first natural language representation with the second natural language representation; and
outputting, by the generative response engine, a customized combined recommendation for the user account using the combined natural language representation.

16. The computing system of claim 9, wherein the instructions further configure the computing system to:
receiving, by the generative response engine, a prompt to output the first customized recommendation for the user account.

17. The computing system of claim 9, wherein the instructions further configure the computing system to:
scheduling, by the first service provider, a prompt to be provided to the generative response engine to recommend a personalization of a service offered to the user account by the first service provider, wherein the prompt includes the first natural language representation of the user account.

18. A non-transitory computer-readable storage medium, the non-transitory computer-readable storage medium including instructions that when executed by one or more processors, cause the one or more processors to:
in an asynchronous process, evaluate, by a generative response engine, past interaction data between a user account and a service provider, wherein the generative response engine is configured to determine what information should be synthesized into a natural language representation of the user account;
create the natural language representation of the user account;
maintain the natural language representation of the user account; and
output, by the generative response engine, a customized recommendation for the user account using the natural language representation.

19. The non-transitory computer-readable storage medium of claim 18, wherein the generative response engine was trained to create the natural language representation that represents an interest of the user account in consumption of a category of services associated with the service provider.

20. The non-transitory computer-readable storage medium of claim 18, wherein the maintaining the natural language representation of the user account includes maintaining multiple natural language representations of the user account, wherein a first natural language representation of the multiple natural language representations represents an interest of the user account in consumption of a first category of services, and wherein a second natural language representation of the multiple natural language representations represents an interest of the user account in consumption of a second category of services.
